(19) United States
(12) Patent Application Publication
(10) Pub. No.: US 2020/0254824 A1
(43) Pub. Date: Aug. 13, 2020

(54) TREAD FOR A TIRE

(71) Applicant: The Goodyear Tire & Rubber Company, Akron, OH (US)

(72) Inventors: Lassi Mikael Hartikainen, Luxembourg (LU); Julien Dominique Gilbert Majerus, Bastogne (BE); Geoffrey Stephane Marcel Ghislain Virlez, Arlon (BE); Beni Rukundo, Arlon (BE); Olaf Matthias Tobias Theisen, Sefferweich (DE)

(21) Appl. No.: 16/273,548

(22) Filed: Feb. 12, 2019

(51) Int. Cl. B60C 11/12; B60C 11/03

(52) U.S. Cl. CPC B60C 11/124; B60C 11/0302; B60C 11/0309; B60C 2011/0372; B60C 11/1281; B60C 2011/0367; B60C 11/1259

(57) ABSTRACT

A tire tread includes a middle rib formed by two circumferential main grooves extending along a tire circumferential direction, a first shoulder rib disposed axially outward from the center rib and one of the circumferential main grooves, and a second shoulder rib disposed axially outward from the center rib and the other of the two circumferential main grooves. The middle rib has a plurality of sipes inclined oppositely with respect to a tire rotational direction such that the sipes extend farther away from a rotational axis of the tire tread as the sipes extend in the tire rotational direction. The middle rib thereby defines a row of circumferentially extending tread elements having chamfers at trailing edges of the tread elements.

### Field of the Invention

The present patent application is directed to a tire and, in particular, a tire tread with narrow grooves in blocks or ribs of the tire tread.

### BACKGROUND OF THE INVENTION

Conventionally, tread design optimization methods tend to impact wet and dry braking in opposite directions. Decoupling/adding cuts may generally improve wet braking distance while higher stiffness/higher contact area may improve dry braking distance. A method for eliminating this trade-off and improving both wet and dry braking would be desireable. A tread block design in accordance with the present invention may improve wet and dry braking distance with tilted sipes combined with a chamfer.

### SUMMARY OF THE INVENTION

A tire tread in accordance with the present invention includes a middle rib formed by two circumferential main grooves extending along a tire circumferential direction, a first shoulder rib disposed axially outward from the center rib and one of the circumferential main grooves, and a second shoulder rib disposed axially outward from the center rib and the other of the two circumferential main grooves. The middle rib has a plurality of sipes inclined oppositely with respect to a tire rotational direction such that the sipes extend farther away from a rotational axis of the tire tread as the sipes extend in the tire rotational direction. The middle rib thereby defines a row of circumferentially extending tread elements having chamfers at trailing edges of the tread elements.

According to another aspect of the tire tread, the chamfers extend at an angle between 20 degrees and 40 degrees relative to a radial direction of the tire tread.

According to still another aspect of the tire tread, the chamfers extend at an angle between 25 degrees and 35 degrees relative to a radial direction of the tire tread.

According to yet another aspect of the tire tread, the chamfers extend at an angle of about 30 degrees relative to a radial direction of the tire tread.

According to still another aspect of the tire tread, the sipes extend at an angle between 10 degrees and 30 degrees relative to a radial direction of the tire tread.

According to yet another aspect of the tire tread, the sipes extend at an angle between 17 degrees and 23 degrees relative to a radial direction of the tire tread.

According to still another aspect of the tire tread, the sipes extend at an angle of about 20 degrees relative to a radial direction of the tire tread.

According to yet another aspect of the tire tread, the middle rib has an axial width between 15.0 mm and 30.0 mm.

According to still another aspect of the tire tread, the middle rib has an axial width between 17.0 mm and 26.0 mm.

According to yet another aspect of the tire tread, the middle rib has an axial width of about 21.5 mm.

According to still another aspect of the tire tread, the sipes have a radial depth between 5.0 mm and 7.0 mm.

According to yet another aspect of the tire tread, the sipes have a radial depth between 5.5 mm and 6.5 mm.

According to still another aspect of the tire tread, the sipes have a radial depth of about 6.0 mm.

According to yet another aspect of the tire tread, the sipes have radially upper part and a radially lower part, the chamfers comprising an entire wall of one wall of the radially upper part, the radially upper part having a radial depth between 0.75 mm and 1.75 mm.

According to still another aspect of the tire tread, the sipes have radially upper part and a radially lower part, the chamfers comprising an entire wall of one wall of the radially upper part, the radially upper part having a radial depth between 1.00 mm and 1.50 mm.

According to yet another aspect of the tire tread, the sipes have radially upper part and a radially lower part, the chamfers comprising an entire wall of one wall of the radially upper part, the radially upper part having a radial depth about 1.25 mm.

According to still another aspect of the tire tread, the sipes have a radially upper part and a radially lower part, the radially lower part having an uniform circumferential width between 0.50 mm and 1.50 mm.

According to yet another aspect of the tire tread, the sipes have a radially upper part and a radially lower part, the radially lower part having an uniform circumferential width between 0.75 mm and 1.25 mm.

According to still another aspect of the tire tread, the sipes have a radially upper part and a radially lower part, the radially lower part having an uniform circumferential width of about 1.00 mm.

### Definitions

As used herein and in the claims:

“Apex” means an elastomeric filler located radially above the bead core and between the plies and the turnup ply.

“Annular” means formed like a ring.

“Aspect ratio” means the ratio of a tire section height to its section width.

“Aspect ratio of a bead cross-section” means the ratio of a bead section height to its section width.

“Asymmetric tread” means a tread that has a tread pattern not symmetrical about the centerplane or equatorial plane EP of the tire.

“Axial” and “axially” refer to lines or directions that are parallel to the axis of rotation of the tire.

“Bead” means that part of the tire comprising an annular tensile member wrapped by ply cords and shaped, with or without other reinforcement elements such as flippers, chippers, apexes, toe guards and chafers, to fit the design rim.

“Belt structure” means at least two annular layers or plies of parallel cords, woven or unwoven, underlying the tread, unanchored to the bead, and having cords inclined respect to the equatorial plane of the tire. The belt structure may also include plies of parallel cords inclined at relatively low angles, acting as restricting layers.

“Bias tire” (cross ply) means a tire in which the reinforcing cords in the carcass ply extend diagonally across the tire from bead to bead at about a 25° to 65° angle with respect to equatorial plane of the tire. If multiple plies are present, the ply cords run at opposite angles in alternating layers.

“Breakers” means at least two annular layers or plies of parallel reinforcement cords having the same angle with reference to the equatorial plane of the tire as the parallel reinforcing cords in carcass plies. Breakers are usually associated with bias tires.

“Cable” means a cord formed by twisting together two or more plied yarns.

“Carcass” means the tire structure apart from the belt structure, tread, undertread, and sidewall rubber over the plies, but including the beads.

“Casing” means the carcass, belt structure, beads, sidewalls and all other components of the tire excepting the tread and undertread, i.e., the whole tire.

“Chipper” refers to a narrow band of fabric or steel cords located in the bead area whose function is to reinforce the bead area and stabilize the radially inwardmost part of the sidewall.

“Circumferential” and “circumferentially” mean lines or directions extending along the perimeter of the surface of the annular tire parallel to the equatorial plane (EP) and perpendicular to the axial direction; it can also refer to the direction of the sets of adjacent circular curves whose radii define the axial curvature of the tread, as viewed in cross section.

“Cord” means one of the reinforcement strands of which the reinforcement structures of the tire are comprised.

“Cord angle” means the acute angle, left or right in a plan view of the tire, formed by a cord with respect to the equatorial plane. The “cord angle” is measured in a cured but uninflated tire.

“Crown” means that portion of the tire within the width limits of the tire tread.

“Denier” means the weight in grams per 9000 meters (unit for expressing linear density). “Dtex” means the weight in grams per 10,000 meters.

“Density” means weight per unit length.

“Elastomer” means a resilient material capable of recovering size and shape after deformation.

“Equatorial plane (EP)” means the plane perpendicular to the tire's axis of rotation and passing through the center of its tread; or the plane containing the circumferential centerline of the tread.

“Fabric” means a network of essentially unidirectionally extending cords, which may be twisted, and which in turn are composed of a plurality of a multiplicity of filaments (which may also be twisted) of a high modulus material.

“Fiber” is a unit of matter, either natural or man-made that forms the basic element of filaments. Characterized by having a length at least 100 times its diameter or width.

“Filament count” means the number of filaments that make up a yarn. Example: 1000 denier polyester has approximately 190 filaments.

“Flipper” refers to a reinforcing fabric around the bead wire for strength and to tie the bead wire in the tire body.

“Footprint” means the contact patch or area of contact of the tire tread with a flat surface at zero speed and under normal load and pressure.

“Gauge” refers generally to a measurement, and specifically to a thickness measurement.

“Groove” means an elongated void area in a tread that may extend circumferentially or laterally about the tread in a straight, curved, or zigzag manner. Circumferentially and laterally extending grooves sometimes have common portions. The “groove width” may be the tread surface occupied by a groove or groove portion divided by the length of such groove or groove portion; thus, the groove width may be its average width over its length. Grooves may be of varying depths in a tire. The depth of a groove may vary around the circumference of the tread, or the depth of one groove may be constant but vary from the depth of another groove in the tire. If such narrow or wide grooves are of substantially reduced depth as compared to wide circumferential grooves, which they interconnect, they may be regarded as forming “tie bars” tending to maintain a rib-like character in the tread region involved. As used herein, a groove is intended to have a width large enough to remain open in the tires contact patch or footprint.

“High tensile steel (HT)” means a carbon steel with a tensile strength of at least 3400 MPa at 0.20 mm filament diameter.

“Inner” means toward the inside of the tire and “outer” means toward its exterior.

“Innerliner” means the layer or layers of elastomer or other material that form the inside surface of a tubeless tire and that contain the inflating fluid within the tire.

“Inboard side” means the side of the tire nearest the vehicle when the tire is mounted on a wheel and the wheel is mounted on the vehicle.

“LASE” is load at specified elongation.

“Lateral” means an axial direction.

“Lay length” means the distance at which a twisted filament or strand travels to make a 360 degree rotation about another filament or strand.

“Load range” means load and inflation limits for a given tire used in a specific type of service as defined by tables in The Tire and Rim Association, Inc.

“Mega tensile steel (MT)” means a carbon steel with a tensile strength of at least 4500 MPa at 0.20 mm filament diameter.

“Net contact area” means the total area of ground contacting elements between defined boundary edges as measured around the entire circumference of the tread.

“Net-to-gross ratio” means the total area of ground contacting tread elements between lateral edges of the tread around the entire circumference of the tread divided by the gross area of the entire circumference of the tread between the lateral edges.

“Non-directional tread” means a tread that has no preferred direction of forward travel and is not required to be positioned on a vehicle in a specific wheel position or positions to ensure that the tread pattern is aligned with the preferred direction of travel. Conversely, a directional tread pattern has a preferred direction of travel requiring specific wheel positioning.

“Normal load” means the specific design inflation pressure and load assigned by the appropriate standards organization for the service condition for the tire.

“Normal tensile steel (NT)” means a carbon steel with a tensile strength of at least 2800 MPa at 0.20 mm filament diameter.

“Outboard side” means the side of the tire farthest away from the vehicle when the tire is mounted on a wheel and the wheel is mounted on the vehicle.

“Ply” means a cord-reinforced layer of rubber-coated radially deployed or otherwise parallel cords.

“Radial” and “radially” mean directions radially toward or away from the axis of rotation of the tire.

“Radial ply structure” means the one or more carcass plies or which at least one ply has reinforcing cords oriented at an angle of between 65 degrees and 90 degrees with respect to the equatorial plane of the tire.

“Radial ply tire” means a belted or circumferentially-restricted pneumatic tire in which at least one ply has cords which extend from bead to bead are laid at cord angles between 65° and 90° with respect to the equatorial plane of the tire.

“Rib” means a circumferentially extending strip of rubber on the tread which is defined by at least one circumferential groove and either a second such groove or a lateral edge, the strip being laterally undivided by full-depth grooves.

“Rivet” means an open space between cords in a layer.

“Section height” means the radial distance from the nominal rim diameter to the outer diameter of the tire at its equatorial plane.

“Section width” means the maximum linear distance parallel to the axis of the tire and between the exterior of its sidewalls when and after it has been inflated at normal pressure for 24 hours, but unloaded, excluding elevations of the sidewalls due to labeling, decoration or protective bands.

“Self-supporting run-flat” means a type of tire that has a structure wherein the tire structure alone is sufficiently strong to support the vehicle load when the tire is operated in the uninflated condition for limited periods of time and limited speed. The sidewall and internal surfaces of the tire may not collapse or buckle onto themselves due to the tire structure alone (e.g., no internal structures).

“Sidewall insert” means elastomer or cord reinforcements located in the sidewall region of a tire. The insert may be an addition to the carcass reinforcing ply and outer sidewall rubber that forms the outer surface of the tire.

“Sidewall” means that portion of a tire between the tread and the bead.

“Sipe” or “incision” means small slots molded into the tread elements of the tire that subdivide the tread surface and improve traction; sipes may be designed to close when within the contact patch or footprint, as distinguished from grooves.

“Spring rate” means the stiffness of tire expressed as the slope of the load deflection curve at a given pressure.

“Stiffness ratio” means the value of a control belt structure stiffness divided by the value of another belt structure stiffness when the values are determined by a fixed three point bending test having both ends of the cord supported and flexed by a load centered between the fixed ends.

“Super tensile steel (ST)” means a carbon steel with a tensile strength of at least 3650 MPa at 0.20 mm filament diameter.

“Tenacity” is stress expressed as force per unit linear density of the unstrained specimen (gm/tex or gm/denier). Used in textiles.

“Tensile” is stress expressed in forces/cross-sectional area. Strength in psi=12,800 times specific gravity times tenacity in grams per denier.

“Toe guard” refers to the circumferentially deployed elastomeric rim-contacting portion of the tire axially inward of each bead.

“Tread” means a molded rubber component which, when bonded to a tire casing, includes that portion of the tire that comes into contact with the road when the tire is normally inflated and under normal load.

“Tread element” or “traction element” means a rib or a block element.

“Tread width” means the arc length of the tread surface in a plane including the axis of rotation of the tire.

“Turnup end” means the portion of a carcass ply that turns upward (i.e., radially outward) from the beads about which the ply is wrapped.

“Ultra tensile steel (UT)” means a carbon steel with a tensile strength of at least 4000 MPa at 0.20 mm filament diameter.

“Vertical deflection” means the amount that a tire deflects under load.

“Yarn” is a generic term for a continuous strand of textile fibers or filaments. Yarn occurs in the following forms: (1) a number of fibers twisted together; (2) a number of filaments laid together without twist; (3) a number of filaments laid together with a degree of twist; (4) a single filament with or without twist (monofilament); and (5) a narrow strip of material with or without twist.

### BRIEF DESCRIPTION OF THE DRAWINGS

The accompanying drawings, which are incorporated in, and constitute a part of, this specification, illustrate examples of the present invention and, together with a general description of the present invention given above, and the detailed description given below, serve to explain the present invention.

FIG. 1 is a schematic orthogonal view of a tire tread in accordance with the present invention;

FIG. 2 is a schematic perspective view of part of the tire tread of FIG. 1;

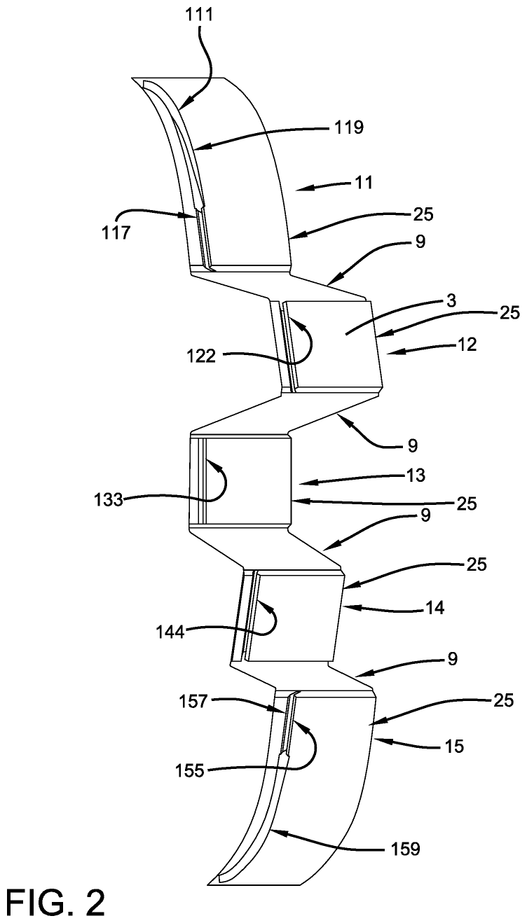

FIG. 3 is a schematic perspective view of another part of the tire tread of FIG. 1;

FIG. 4 is a schematic side view of the tire tread of FIG. 1 in an ideally loaded condition; and

FIG. 5 is a schematic side detail of one of the sipes of FIG. 4.

### DETAILED DESCRIPTION OF EXAMPLES OF THE PRESENT INVENTION

This description is made for the purpose of illustrating the general principles of the present invention and should not be understood in a limiting sense. The scope of the present invention is best determined by reference to the appended claims. The reference numerals as depicted in the drawings are the same as those referred to in this specification. Any further structural limitations of the example tire and tread may be specified in U.S. Patent No. 9,174,495, herein incorporated by reference in its entirety.

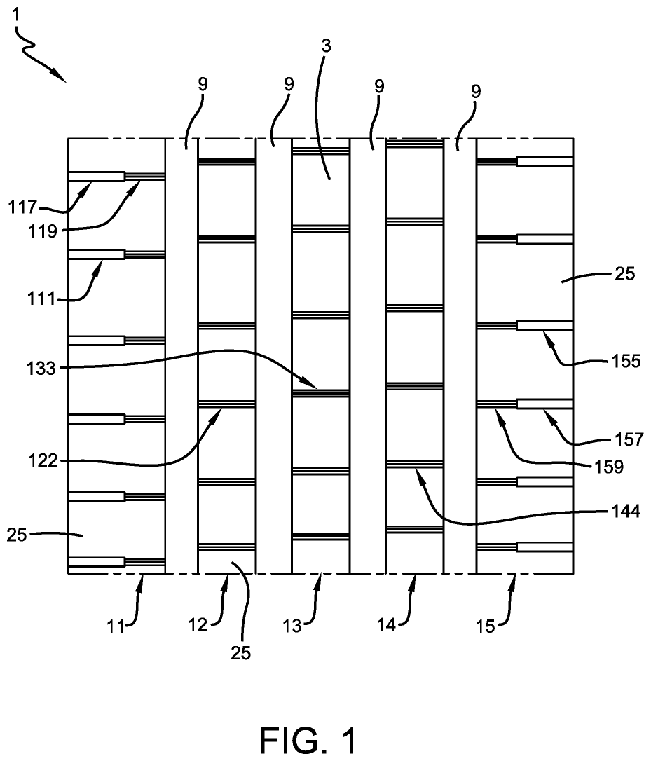

FIG. 1 shows an example pneumatic or non-pneumatic tire tread 1 having a contact surface 3, such as a road, and a first circumferential shoulder rib 11, a second circumferential intermediate rib 12, a third circumferential center rib 13, a fourth circumferential intermediate rib 14, and a fifth circumferential shoulder rib 15, each separated axially by a circumferential groove 9. The first rib 11 may have axially extending first sipes 111. The second rib 12 may have axially extending second sipes 122. The third rib 13 may have axially extending third sipes 133. The fourth rib 14 may have axially extending fourth sipes 144. The fifth rib 15 may have axially extending fifth sipes 155. The first sipes 111 and the fifth sipes 155 axially outer straight portions 117, 157 axially transitioning to axially inner angled portions 119, 159, respectively. The inner angled portions 119, 159 and the second, third and fourth ribs 122, 133, 144 may have axial thicknesses between 15.0 mm and 30.0 mm, or 17.0 mm and 26.0 mm, or between 21.0 mm and 23.0 mm, or 21.5 mm.

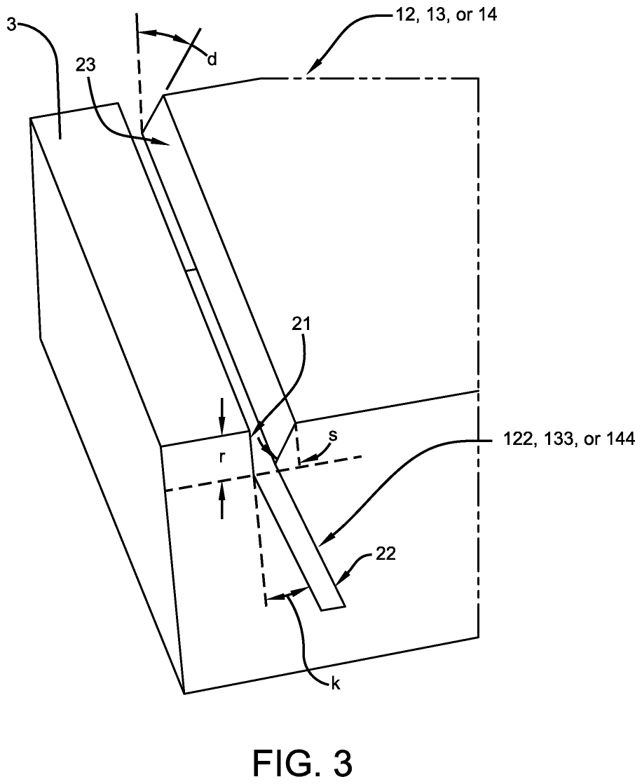

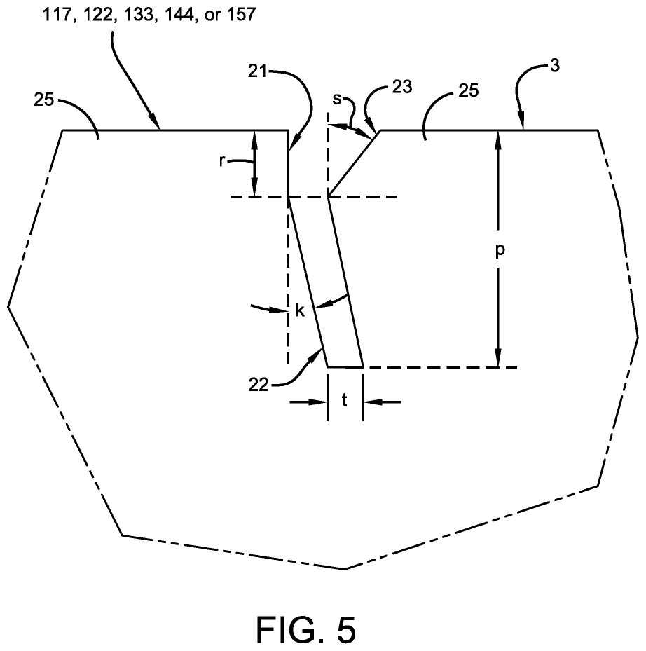

As shown in FIGS. 3 and 5, the inner angled portions 119, 159 of the first and fifth ribs 11, 15, the second sipes 122, the third sipes 133, and the fourth sipes 144 may extend radially inward (and circumferentially) at a first angle k to a radial depth p from the contact surface 3. Angle k may be between 10 degrees and 30 degrees, or between 17 degrees and 23 degrees, or 20 degrees. The radial depth p may be between 5.0 mm and 7.0 mm, or 5.5 mm and 6.5 mm, or 6.0 mm. Each inner angled portion 119, 159 and each sipe 122, 133, 144 may have a radially upper part 21 and a radially lower part 22. One wall of the radially upper part 21 may extend directly radially inward to a depth of r from the contact surface 3. The depth r may be between 0.75 mm and 1.75 mm, or 1.00 mm and 1.50 mm, or 1.25 mm. At the depth r, both sides of the radially lower part 22 of the inner angled portions 119, 159 and the sipes 122, 133, 144 may extend radially inward at the first angle k. The angled radially lower part 22 may have a circumferential thickness t. The thickness t may be between 0.50 mm and 1.50 mm, or between 0.75 mm and 1.25 mm, or 1.00 mm. The other wall of the radially upper part 21 may extend radially outward from the radially lower part 22 at a second angle s to form a chamfer 23 at the radially outermost leading edge of the inner angled portions 119, 159 and the sipes 122, 133, 144. Said another way, this defines a structure of each tread element 25 of the ribs 11, 12, 13, 14, 15 having the chamfer 23 at the trailing edge (e.g., the final edge of a tread element to contact a road surface, etc.) of the tread elements 25. The second angle s may be between 20 degrees and 40 degrees, or between 25 degrees and 35 degrees, or 30 degrees.

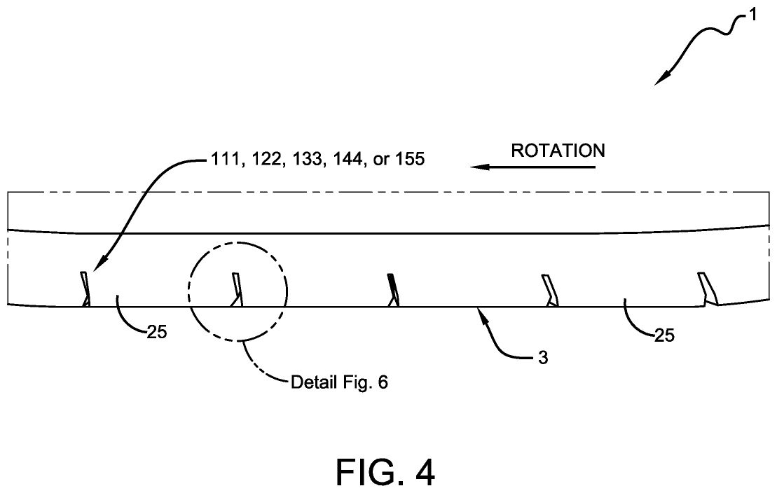

Conventionally, tread design optimization for braking tends to impact wet and dry braking in opposite directions. A general trend is that lower tread stiffness improves wet braking, but penalizes dry braking. The above described sipes 111, 122, 133, 144, 155 may allow optimization of wet braking without the trade-off in dry braking. FIG. 4 illustrate an example of the sipes 111, 122, 133, 144, 155 of the tire tread 1 operating under wet braking conditions.

The present invention has been described with reference to the above examples. Modifications and alterations may occur to others upon reading and understanding of this specification. The specification is intended to include all such modifications and alterations in so far as they come within the scope of the appended claims or the equivalents thereof.

1. A tire tread comprising:
a middle rib formed by two circumferential main grooves extending along a tire circumferential direction;
a first shoulder rib disposed axially outward from the center rib and one of the circumferential main grooves; and
a second shoulder rib disposed axially outward from the center rib and the other of the two circumferential main grooves,
the middle rib having a plurality of sipes inclined oppositely with respect to a tire rotational direction such that the sipes extend farther away from a rotational axis of the tire tread as the sipes extend in the tire rotational direction, the middle rib thereby comprising a row of circumferentially extending tread elements having chamfers at trailing edges of the tread elements.

2. The tire tread as set forth in claim 1 wherein the chamfers extend at an angle between 20 degrees and 40 degrees relative to a radial direction of the tire tread.

3. The tire tread as set forth in claim 1 wherein the chamfers extend at an angle between 25 degrees and 35 degrees relative to a radial direction of the tire tread.

4. The tire tread as set forth in claim 1 wherein the chamfers extend at an angle of about 30 degrees relative to a radial direction of the tire tread.

5. The tire tread as set forth in claim 1 wherein the sipes extend at an angle between 10 degrees and 30 degrees relative to a radial direction of the tire tread.

6. The tire tread as set forth in claim 1 wherein the sipes extend at an angle between 17 degrees and 23 degrees relative to a radial direction of the tire tread.

7. The tire tread as set forth in claim 1 wherein the sipes extend at an angle of about 20 degrees relative to a radial direction of the tire tread.

8. The tire tread as set forth in claim 1 wherein the middle rib has an axial width between 15.0 mm and 30.0 mm.

9. The tire tread as set forth in claim 1 wherein the middle rib has an axial width between 17.0 mm and 26.0 mm.

10. The tire tread as set forth in claim 1 wherein the middle rib has an axial width of about 21.5 mm.

11. The tire tread as set forth in claim 1 wherein the sipes have a radial depth between 5.0 mm and 7.0 mm.

12. The tire tread as set forth in claim 1 wherein the sipes have a radial depth between 5.5 mm and 6.5 mm.

13. The tire tread as set forth in claim 1 wherein the sipes have a radial depth of about 6.0 mm.

14. The tire tread as set forth in claim 1 wherein the sipes have radially upper part and a radially lower part, the chamfers comprising an entire wall of one wall of the radially upper part, the radially upper part having a radial depth between 0.75 mm and 1.75 mm.

15. The tire tread as set forth in claim 1 wherein the sipes have radially upper part and a radially lower part, the chamfers comprising an entire wall of one wall of the radially upper part, the radially upper part having a radial depth between 1.00 mm and 1.50 mm.

16. The tire tread as set forth in claim 1 wherein the sipes have radially upper part and a radially lower part, the chamfers comprising an entire wall of one wall of the radially upper part, the radially upper part having a radial depth about 1.25 mm.

17. The tire tread as set forth in claim 1 wherein the sipes have a radially upper part and a radially lower part, the radially lower part having a uniform circumferential width between 0.50 mm and 1.50 mm.

18. The tire tread as set forth in claim 1 wherein the sipes have a radially upper part and a radially lower part, the radially lower part having a uniform circumferential width between 0.75 mm and 1.25 mm.

19. The tire tread as set forth in claim 1 wherein the sipes have a radially upper part and a radially lower part, the radially lower part having a uniform circumferential width of about 1.00 mm.
